(19) United States
(12) Patent Application Publication
(10) Pub. No.: US 2009/0319186 A1
(43) Pub. Date: Dec. 24, 2009

(54) METHOD AND APPARATUS FOR DETERMINING A NAVIGATIONAL STATE OF A VEHICLE

(75) Inventors: Anirudh Kumar, Bangalore (IN); Kailash Krishnaswamy, Little Canada, MN (US); Shrikant P. Rao, Bangalore (IN); Peter Lommel, St. Cloud, MN (US); Subhabrata Ganguli, Plymouth, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/145,096

(22) Filed: Jun. 24, 2008

(51) Int. Cl. G01C 21/16

(52) U.S. Cl. 701/216

(57) ABSTRACT

Methods and apparatus are provided for determining a navigational state of a vehicle, the vehicle having at least one pivotable wheel and a plurality of front wheels. The apparatus comprises a steering angle sensor coupled to the at least one pivotable wheel for determining a steering angle, a plurality of wheel speed sensors each coupled to a different one of the plurality of pivotable wheels for determining an angular velocity of each of the plurality of pivotable wheels, a GPS receiver coupled to the vehicle for receiving GPS positioning data, and a processor coupled to the steering angle sensor, the plurality of wheel speed sensors, and the GPS receiver. The processor is configured to determine a yaw rate for the vehicle based on the positioning data, the steering angle, and the longitudinal angular velocity of each of the plurality of front wheels, and integrate the yaw rate to determine a heading for the vehicle.

### TECHNICAL FIELD

The present invention generally relates to vehicle navigation, and more particularly relates to a method and apparatus for determining a navigational state of a vehicle.

### BACKGROUND

Modern vehicles often include vehicle control systems for providing input regarding the operation of the vehicle as it travels along a surface. For example, the vehicle may be an autonomous vehicle that travels along a predetermined path comprised of a plurality of waypoints. In this case, the vehicle control unit determines the appropriate steering angle and velocity for the vehicle as it travels to the next sequential waypoint. In other instances, the vehicle may be a user-controlled vehicle and the vehicle control system may provide the appropriate steering angle and velocity based on input from the user.

Such vehicle control systems often include a navigation unit for determining the navigational state of the vehicle (e.g., its position, heading, longitudinal velocity, and lateral acceleration). Known navigation units often comprise an inertial measurement unit (IMU) and a global positioning system (GPS) receiver. The GPS receiver receives positioning data from a GPS system at a specific frequency (e.g., 1 HZ), which the navigation unit utilizes to determine the navigational state of the vehicle. The IMU includes a plurality of sensors, gyroscopes, and accelerometers for generating data that the navigation unit uses to determine the navigational state of the vehicle between signals from the GPS system.

Although these prior art navigation units are effective, they require the use of dedicated sensors, gyroscopes, and accelerometers, increasing the cost of the vehicle. In addition, these devices are subject to measurement errors due to drifts in the accelerometers and gyroscopes that may occur while the vehicle is traveling.

Accordingly, it is desirable to provide a navigation unit that does not require the use of dedicated and costly sensors. In addition, it is also desirable to provide a navigation unit that does not use instruments such as accelerometers and gyroscopes that are subject to drift errors. Furthermore, other desirable features and characteristics of the present invention will become apparent from the subsequent detailed description of the invention and the appended claims, taken in conjunction with the accompanying drawings and this background of the invention.

### BRIEF SUMMARY

An apparatus is provided for determining a navigational state of a vehicle, the vehicle having at least one pivotable wheel a plurality of front wheels. The apparatus comprises a steering angle sensor coupled to the at least one pivotable wheel for determining a steering angle, a plurality of wheel speed sensors each coupled to a different one of the plurality of pivotable wheels for determining an angular velocity of each of the plurality of pivotable wheels, a GPS receiver coupled to the vehicle for receiving GPS positioning data, and a processor coupled to the steering angle sensor, the plurality of wheel speed sensors, and the GPS receiver. The processor is configured to determine a yaw rate for the vehicle based on the GPS positioning data, the steering angle, and the longitudinal angular velocity of each of the plurality of pivotable wheels, and integrate the yaw rate to determine a heading for the vehicle.

A method is provided for determining a navigational state of a vehicle, the vehicle comprising at least one pivotable wheel, a front left wheel, and a front right wheel. The method comprises receiving a steering angle from a steering angle sensor coupled to the at least one pivotable wheel, receiving a longitudinal angular velocity of the front left wheel from a front left wheel speed sensor coupled to the front left wheel, receiving a longitudinal angular velocity of the front right wheel from a front right wheel speed sensor coupled to the front right wheel, receiving GPS positioning data from a GPS receiver, determining a yaw rage for the vehicle based on the longitudinal angular velocity of the front left wheel, the longitudinal angular velocity of the front right wheel, the steering angle, and the GPS positioning data, integrating the yaw rate to determine a heading of the vehicle; and setting an appropriate steering angle and velocity for the vehicle based on data including the heading.

### BRIEF DESCRIPTION OF THE DRAWINGS

The present invention will hereinafter be described in conjunction with the following drawing figures, wherein like numerals denote like elements, and

FIG. 1 depicts an exemplary vehicle;

FIG. 2 depicts the vehicle of FIG. 1 as it travels along a predetermined path;

FIG. 3 is a block diagram of an exemplary vehicle control system suitable for use with the vehicle of FIG. 1; and

FIG. 4 is a schematic depiction of an exemplary method for determining the heading of the vehicle of FIG. 1;

FIG. 5 is a schematic depiction of an exemplary method for estimating the position of the vehicle of FIG. 1; and

FIG. 6 is a schematic depiction of a method for determining a plurality of feedback values.

### DETAILED DESCRIPTION

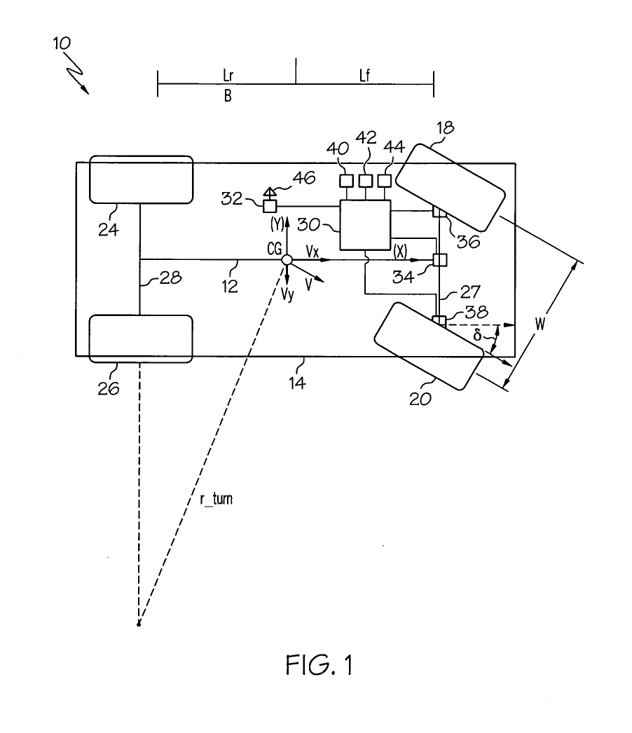

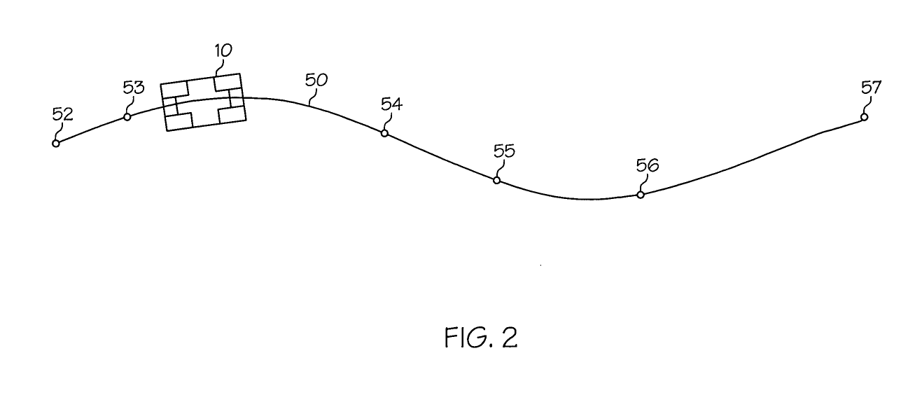

The following detailed description is merely exemplary in nature and is not intended to limit the invention or the application and uses of the invention. Furthermore, there is no intention to be bound by any theory presented in the preceding background or the following detailed description. Although the diagrams shown herein depict example arrangements of elements, additional intervening elements, devices, features, or components may be present in an actual embodiment. It should also be understood that FIGS. 1-6 are merely illustrative and, particularly with reference to FIGS. 1 and 2, may not be drawn to scale. As used herein, the word “wheel” whether singular or plural is intended to be inclusive of the tire mounted thereon. For example, reference to data from a particular wheel is understood to include the desired information about the tire mounted thereon.

FIG. 1 depicts an exemplary vehicle 10. The vehicle 10 includes a chassis 12, a body 14, a front left wheel 18, a front right wheel 20, and at least one rear wheel (e.g., wheels 24 and 26 in FIG. 1). The body 14 is arranged on the chassis 12 and substantially encloses the other components of the vehicle 10. The body 14 and the chassis 12 may jointly form a frame 14. The front left and right wheels 18 and 20 and the rear wheels 24 and 26 are each rotatably coupled to the vehicle 10 near a different corner of the frame 14. In the illustrated embodiment, the front wheels 18, and 20 are also configured to pivot with respect to the frame 14 while the rear wheels 24, 26 do not pivot with respect to the frame 14.

It should be noted that while the depicted embodiment describes one exemplary wheel configuration (e.g., two front pivoting wheels 18, 20 and two rear wheels 24, 26 that do not pivot) other embodiments of the present invention my include additional wheel configurations. For example, in one alternative embodiment the rear wheels 24, 26 of the vehicle 10 pivot with respect to the frame 14 while the front wheels 18, 20 do not pivot. Further, in still other embodiments the vehicle 10 may include only a rear wheel that pivots and two front wheels that do not pivot.

The vehicle 10 has a center of gravity (CG) located between the front wheels 18, 20 and the rear wheels 24 and 26. The wheel base (B) of the vehicle 10 comprises two separate components. The first is a distance (Lf) between CG and the closest point on a line 27 that extends between the positions where the front wheels 18 and 20 are coupled to the vehicle 10. The second is a distance (Lr) between CG and the nearest point on a line 28 that extends between the positions where the at least one rear wheel (e.g., the rear wheels 24 and 26 depicted in FIG. 2) is coupled to the vehicle 10. The vehicle 10 also has a track width (W). In the illustrated embodiment, W is equal to the shortest distance between the longitudinal axis of the front left wheel 18 and the longitudinal axis of the front right wheel 20.

As depicted, the vehicle 10 moves along an underlying terrain at velocity (V). V has two separate components: an x-component or longitudinal velocity (Vx), and a y-component or lateral velocity (Vy) of the vehicle 10. Vx and Vy are both oriented within a body coordinate system (having its origin at CG) of the body of the vehicle 10. The x-axis or longitudinal axis extends longitudinally through the vehicle 10, passing through CG. The y-axis or lateral axis is orthogonal to the x-axis. In addition, the vehicle 10 is traveling with a current steering angle (δ) causing the vehicle 10 to turn. δ is the angle that at least one pivoting wheel (e.g., the front right wheel 20 and/or the front left wheel 18 in the depicted embodiment) is turned with respect to a line that is parallel with the x-axis. For example, in the depicted embodiment δ may be the angle that the inside wheel (e.g., the front left wheel 18 if the vehicle is turning left and the front right wheel 20 if the vehicle is turning right) is turned. The turn radius (r_turn) of the vehicle 10 is the radius of the circle in which CG would travel if δ were held constant.

The vehicle 10 also includes a vehicle control system 30 that is coupled to a GPS receiver 32, a steering angle sensor 34, a front left wheel speed sensor 36, and a front right wheel speed sensor 38. In addition, the vehicle control system 30 is coupled to a steering controller 40 for controlling the steering angle of the vehicle 10, an acceleration controller 42 for increasing the velocity of the vehicle 10, and a brake controller 44 for decreasing the velocity of the vehicle 10. As further described below, the vehicle control system 30 provides signals to the steering controller 40, the acceleration controller 42, and the brake controller 44 to adjust the steering angle and the velocity of the vehicle based on the values B, Lr, Lf, W, and δ and input from the GPS receiver 32, the steering angle sensor 34, and the front left and right wheel speed sensors 36 and 38.

The GPS receiver 32 is coupled to the vehicle 10 and receives positioning data, via a wireless antenna 46, from a global positioning system. The positioning data comprises the position (e.g., latitude and longitude) of the vehicle 10 and is received by the GPS receiver 32 at a constant frequency (e.g., 1 Hz). The GPS system is a space-based radio-navigation system that is managed by the United Stated Air Force for the United States. However, it should be understood that the GPS receiver 32 may also be configured for use with other radio-based navigation/global positioning systems, such as GLONASS Navigation Satellite System managed by the Russian Space Agency for the Russian Federation.

The steering angle sensor 34 is coupled to the pivoting wheel or wheels of the vehicle 10 (e.g., the front left wheel 18 or the front right wheel 20) and is configured to determine δ as the vehicle 10 travels along the underlying surface. The front left wheel speed sensor 36 is coupled to the front left wheel 18 and is configured to determine the longitudinal angular velocity (ωL). The front right wheel speed sensor 38 is coupled to the front right wheel 20 and is configured to determine its longitudinal angular velocity (ωR). As used herein, the term “longitudinal angular velocity” of a wheel refers to the rate at which the wheel spins on its axle.

In one embodiment the vehicle 10 is an autonomous vehicle that follows a predetermined path 50 as shown in FIG. 2. The path 50 comprises a plurality of sequential waypoints 52, 53, 54, 55, 56, and, 57, each representing a specific position (e.g., latitude and longitude). The vehicle 10 follows the path 50 by sequentially moving to each waypoint 52-57. The vehicle control system 30 (FIG. 1) determines the appropriate steering angle and velocity for the vehicle 10 as it moves to the next sequential waypoint 54 based on input from the GPS receiver 32, the steering angle sensor 34, and the front left and right wheel speed sensors 36 and 38.

It should be noted that in other embodiments of the present invention, the vehicle 10 is a user-controlled vehicle and the vehicle control system 30 (FIG. 1) determines the appropriate steering angle and velocity for the vehicle 10 based on input from the GPS receiver 32, steering angle sensor 34, front left and right wheel speed sensors 36 and 38, and the user. In this embodiment, the vehicle control system 30 may utilize the input from the GPS receiver 32, steering angle sensor 34, and front left and right wheel speed sensor 36 and 38 to avoid unsafe or unstable travel conditions for the vehicle 10.

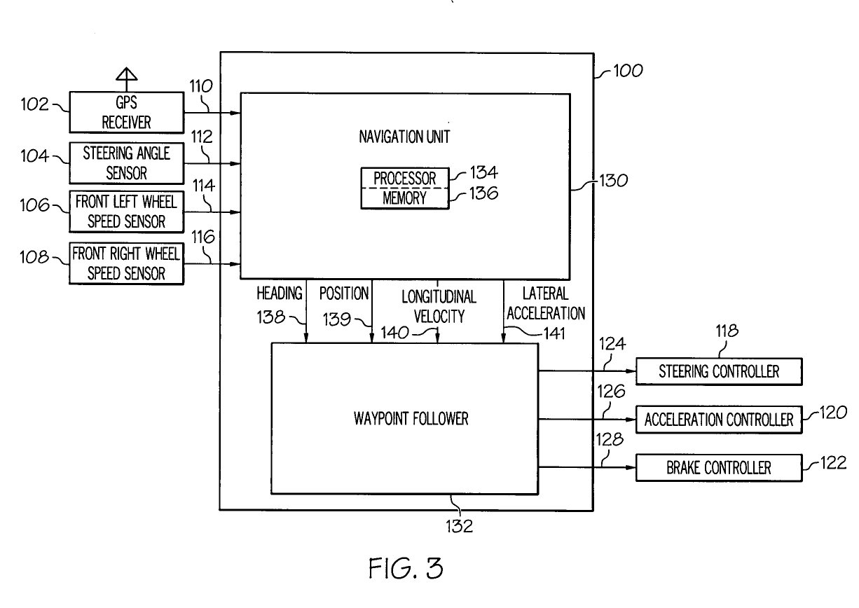

FIG. 3 is a depiction of an exemplary vehicle control system 100 for use with the vehicle 10 of FIG. 1. The vehicle control system 100 is coupled to a GPS receiver 102, a steering angle sensor 104, a front left wheel speed sensor 106 and a front right wheel speed sensor 108. The GPS receiver 102 includes a wireless antenna 109 and transmits the positioning data that it receives from the GPS system to the vehicle control system 100 via a positioning data signal 110. The steering angle sensor 104 transmits the steering angle (δ) to the vehicle control system 100 via a steering angle signal 112. The front left wheel speed sensor 114 transmits the longitudinal angular velocity (ωL) of the front left wheel 18 (FIG. 1) to the vehicle control system 100 via a front left wheel speed signal 114. Finally, the front right wheel speed sensor 108 transmits the longitudinal angular velocity (ωR) of the front right wheel 20 (FIG. 1) to the vehicle control system 100 via a front right wheel speed signal 116.

The vehicle control system 100 is also coupled to a steering controller 118, a acceleration controller 120, and a brake controller 122. The steering controller 118 controls the steering angle and the acceleration controller 120 and brake controller 122 each control the velocity of the vehicle 10 (FIG. 1). The vehicle control system 100 transmits a steering control signal 124 to the steering controller 118 to adjust the steering angle of the vehicle 10 (FIG. 1). Further, the vehicle control system 100 transmits an acceleration control signal 126 to the acceleration controller 120 or a brake control signal 128 to the brake controller 122 to adjust the velocity of the vehicle 10 (FIG. 1).

The vehicle control system 100 includes a navigation unit 130 and a waypoint follower 132. The navigation unit 130 includes at least one processor 134 and a memory 136. The processor 134 may be a programmable logic control system (PLC), a microprocessor, or any other type of electronic controller known by those skilled in the art. It may be comprised of one or more micro-controllers, central processing units, state machines, programmable logic arrays, network logical arrays, or gates, ASIC processors, software-based controllers, combination logic, combinations thereof, and a variety of other controllers known by one skilled in the art. The memory 136 is comprised of electronic memory that is configured to store information including instructions for the processor 134 and data regarding the vehicle 10 (FIG. 1). It should be understood, that the processor 134 and the memory 136 may be dedicated components for use only by the navigation unit or they may be shared components that are used by other modules of the vehicle control system such as the waypoint follower 132.

With regard to FIGS. 1 and 3, the memory 136 is configured to store predetermined attributes of the vehicle, such as the B, Lf, Lr, W and the average of the radii of the front left and right wheels 18 and 20 (r_wheels). The processor 134 utilizes these values along with the positioning data, δ, ωL, and ωR received from the navigation unit 130 via the positioning data signal 110, the steering angle signal 112, and the front left and right wheel speed signals 114 and 116, respectively, to continuously determine the navigational state of the vehicle 10. As used herein the term “navigational state of the vehicle” refers to the lateral acceleration of the vehicle 10, the x-axis or longitudinal velocity of the vehicle 10, the current position (e.g., latitude and longitude of the vehicle) of the vehicle 10, and the heading of the vehicle 10.

As depicted, the navigation unit 130 transmits the detected navigational state of the vehicle 10 to the waypoint follower 132 via a heading signal 138, a position signal 139, a longitudinal velocity signal 140, and a lateral acceleration signal 141. The waypoint follower 132 determines the appropriate steering angle and velocity for the vehicle 10 based on the signals 138-141 that it receives from the navigation unit 130 and the position of the next waypoint (e.g., waypoint 54 of path 50 as depicted in FIG. 2). The waypoint follower 132 adjusts the steering angle of the vehicle 10 via the steering controller 118 and the velocity of the vehicle 10 via the acceleration controller 120 and the brake controller 122 appropriately.

In other embodiments, the vehicle control system 100 may include a drive controller that is coupled to the navigation unit 130 in place of the waypoint follower 132 and receives input from the driver of the vehicle 10. In this case, the drive controller would adjust the steering angle and the velocity of the vehicle 10 based both on the input from the driver and on the navigational state of the vehicle 10 as determined by the navigation unit 130.

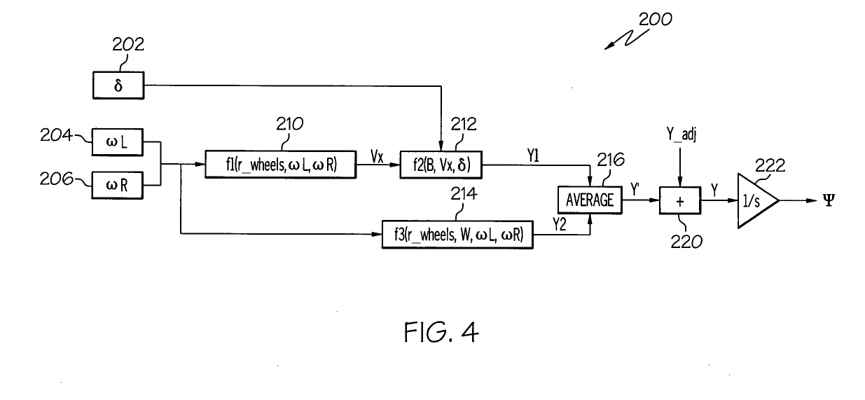

The processor 134 estimates the current heading (Ψ) for the vehicle based on r_wheels, B, W, and the data that the navigation unit 130 receives from the GPS receiver 102, the steering angle sensor 104, and the front left and right wheel speed sensors 106 and 108. The processor 134 transmits Ψ the waypoint follower 132 via heading signal 138. FIG. 4 depicts a schematic of an exemplary method 200 for determining the heading of a vehicle (e.g., the vehicle 10 of FIG. 1). It is to be understood that the certain of the steps described in conjunction with FIG. 4 may be performed in different orders than the illustrated and described order, and/or some steps may be performed in parallel with each other.

With reference to FIGS. 3 and 4, method 200 the navigation unit receives the current steering angle (δ) from the steering angle sensor 104 during step 202, the longitudinal angular velocity (ωL) from the front left wheel speed sensor 106 during step 204, and the longitudinal angular velocity (ωR) from the front right wheel speed sensor 108 during step 206.

Next, during step 210 the processor 134 estimates the longitudinal velocity (Vx) for the center of gravity of the vehicle using a function ƒ1(r_wheels, ωL, ωR) according to the equation:

Vx=r_wheels(ωL+ωR)/2 (1)

where r_wheels is the average of the radii for the front left wheel 18 (FIG. 1) and the front right wheel 20 (FIG. 1).

Next, the processor 134 determines a first yaw rate estimate (Y1) for the vehicle (step 212). Y1 is determined using the function ƒ2(B, Vx, δ) according to the equation:

Y1=(1/B)Vx tan δ (2)

where B is the wheel base of the vehicle (described above with reference to FIG. 1).

The processor 134 determines a second yaw rate estimate (Y2) during step 214. Y2 is determined using the function ƒ3(r_wheels, W, ωL, ωR) according to the equation:

Y2=(r_wheels/W)(ωL−ωR) (3)

where W is the track width of the vehicle (as described above with reference to FIG. 1).

Thus, Y2 is based on ωL and ωR as provided by the front left and right wheel speed sensors 106 and 108, whereas Y1 is based not only on ωL and ωR (because those values are used to determine Vx) but also on δ as provided by the steering angle sensor 104. To decrease the effect of any measurement errors by the steering angle sensor 104 and/or the front left and right wheel speed sensors 106 and 108, the processor 134 averages Y1 and Y2 (step 216) to obtain an average yaw rate estimate (Y′).

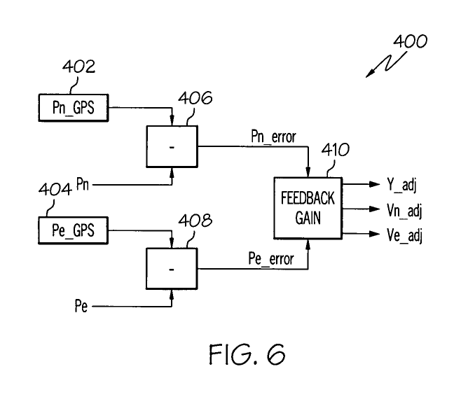

Next, the processor 134 during step 220 the processor adds a yaw rate adjustment (Y_adj) to Y′ to determine the estimated yaw rate for the vehicle (Y). As further described below, the processor 134 determines the value of Y_adj based on the positioning data from the GPS receiver 102 (see FIG. 6). Y_adj adjusts the value of the estimated yaw rate with the goal of increasing its accuracy.

Finally, Y is integrated (step 222) to obtain the heading of the vehicle Ψ. It should be noted that Ψ will be relative to a reference heading. The reference heading may be a heading that is substantially in the North direction, the initial heading of the vehicle before the navigational unit 130 begins to operate, or any other heading that will serve as the basis for the heading measurements that are determined by the navigational unit 130. In instances where the reference heading is equal to the initial heading of the vehicle 10, the value of the reference heading may be set manually or it may be determined from the positioning data that is received from the GPS receiver 102.

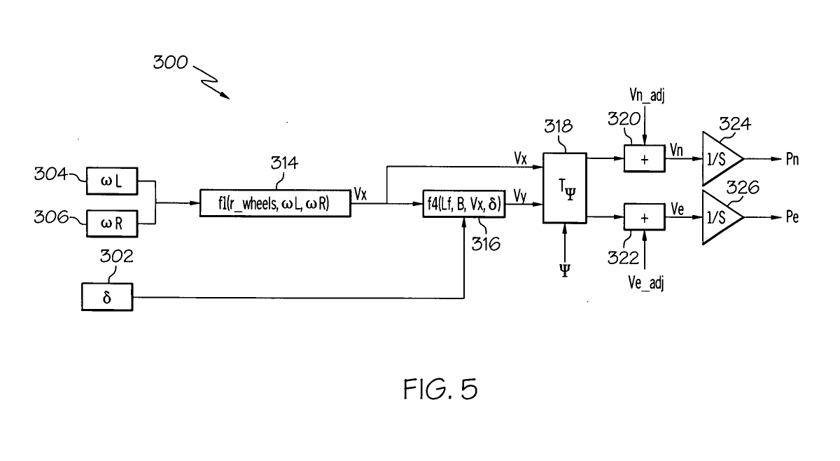

Returning to FIG. 3, the processor 134 estimates the current position of the vehicle 10 (FIG. 1) and transmits that information to the waypoint follower 132 via the position signal 139. FIG. 5 depicts a schematic of an exemplary process 300 for determining the position of a vehicle (e.g., the vehicle 10 of FIG. 1). It is to be understood that the certain of the steps described in conjunction with FIG. 5 may be performed in different orders than the illustrated and described order, and/or some steps may be performed in parallel with each other.

With reference to FIGS. 3 and 5, the navigation unit 130 receives the current steering angle (δ) from steering angle sensor 104 during step 302, the longitudinal angular velocity (ωL) from the front left wheel speed sensor 106 during step 304, and the longitudinal angular velocity (ωR) from the front right wheel speed sensor 108 during step 306.

During step 314, the processor 134 estimates the longitudinal velocity (Vx) of the vehicle. The processor 134 determines Vx using the same function ƒ1(r_wheels, ωL, ωR) that is used during step 210 of method 200. Next, the processor 134 determines the lateral velocity (Vy) for the vehicle (step 316) using a function ƒ4(Lr, B, Vx, δ) according to the equation:

Vy=−(Lr/B)Vx tan δ (4)

where Lr is the distance between the center of gravity of the vehicle and the nearest point on a line 27 that extends through the centers of the rear wheels 24, 26 (as described above with reference to FIG. 1). It should be noted that under some circumstances it may be necessary to substitute Lf for Lr in equation 4. For example, in embodiments in which the rear wheel or wheels (e.g., wheels 24 and 26 of FIG. 1) pivot while the front wheels 18. 20 (FIG. 1) do not pivot, Lf should be used.

The processor 134 utilizes a body-to-inertial-transformation-matrix (TΨ) to transform Vx and Vy from the body coordinate system of the vehicle into an inertial coordinate system. In one embodiment, the inertial coordinate system is an NE (North/East) coordinate system, having an N-axis that extends in the North direction and an E-axis that extends in the East direction. In this embodiment, the processor 134 uses heading (Ψ) that is determined during method 200 (FIG. 4) to generate successive iterations of the body-to-inertial-transformation-matrix and applies that matrix to Vx and Vy, transforming them from the body coordinate system to the NE coordinate system (step 318). As depicted, the result is a North velocity (Vn′) representing the velocity that the vehicle is traveling in the North direction and an East velocity (Ve′) representing the velocity that the vehicle is traveling in the East direction.

Next, the processor 134 adds a North velocity adjustment (Vn_adj) to Vn′ (step 320) to determine the velocity of the vehicle in the North direction (Vn) and an East velocity adjustment (Ve_adj) to Ve′ (step 322) to determine the velocity of the vehicle in the East direction (Ve). As further described below, the processor 134 determines the values Vn_adj and Ve_adj based on the positioning data from the GPS receiver 102 (see FIG. 6).

The processor 134 integrates Vn to obtain a North position (Pn) of the vehicle (step 324) and Ve to determine an East position (Pe) of the vehicle (step 326). It should be noted that Pn is a distance in the North direction from a reference North position (Pn_ref) and Pe is a distance in the East direction from a reference East position (Pe_ref). Pn_ref may be expressed as a latitude and Pe_ref may be expressed as a longitude. Pn_ref and Pe_ref represent the position of the vehicle before the navigation unit 130 begins to determine the navigational state of the vehicle 10 and are used as the initial conditions for determining Pn and Pe. The values of Pn_ref and Pe_ref may be set manually or they may be determined from the positioning data that is received from the GPS receiver 102.

It should also be noted that in some embodiments, the processor 134 uses the positioning data that the navigation unit 130 receives from the GPS receiver 102, rather than Pn and Pe, to determine the position of the vehicle for the purposes of the position signal 139. In such embodiments, the processor 134 is limited by the frequency with which the GPS receiver 102 receives the positioning data (e.g., 1 Hz). However, the processor 134 must still determine the positions Pn and Pe as those positions are required to calculate the feedback gain as described below.

FIG. 6 is a schematic of an exemplary method 400 for determining a plurality of feedback values. As depicted, the method 400 determines a feedback value for the yaw rate (Y of FIG. 4) and the position (Pn and Pe of FIG. 5). With reference to FIGS. 3 and 6, the processor extracts a North position (Pn_gps) for the vehicle (step 402) and an East position (Pe_gps) for the vehicle (step 404) from the positioning data that is received from the GPS receiver 102. As described above, the GPS receiver 102 receives the positioning data from the GPS system at a specific frequency (e.g., 1 Hz) and therefore method 400 is performed only when the GPS receiver 102 receives new positioning data.

In addition, it should be noted that Pn_gps and Pe_gps must have the same frame of reference as the positions Pn and Pe that are determined during method 300. For example, in embodiments in which Pn and Pe are distances from Pn_ref and Pe_ref, the Pn_gps and Pe_gps must also be expressed as being relative to Pn_ref and Pe_ref. Conversely, the processor 134 may convert the values Pn and Pe into a latitude and a longitude based on Pn_ref and Pe_ref.

Next, the processor 134 determines the difference (Pn_error) between Pn_GPS and the Pn (step 406). The processor 134 also determines the difference (Pe_error) between Pe_GPS and Pe (step 408).

During step 410 the processor 134 determines a yaw rate adjustment (Y_adj), a North velocity adjustment (Vn_adj), and an East velocity adjustment (Ve_adj) based on Pn_error, Pe_error, and at least one gain value. Y_adj is the feedback value for the yaw rate (Y of FIG. 4) and Vn_adj and Ve_adj are the feedback adjustments for the position (Pn and Pe) of FIG. 5. For example, in one embodiment Y_adj, Pn_adj, and Pe_adj are determined by placing Pn_error and Pe_error in a 1×2 matrix that is multiplied by a 2×3 matrix comprising a plurality of gain values. The result is a 1×3 matrix that comprises Y_adj, Vn_adj, and Ve_adj. The gain values (e.g., the 2×3 matrix) are tuned manually through a process of trial and error to adjust the Y′ (as described above with reference to FIG. 200) and Ve and Vn (as described above with reference to FIG. 300) with the goal of achieving a Pn_error and Pe_error that are equal to zero.

Returning to FIG. 3, as described above the processor 134 estimates the longitudinal velocity (Vx) for the vehicle during method 200 (FIG. 4) and method 300 (FIG. 5). The processor 134 transmits Vx to the waypoint follower 132 via the longitudinal velocity signal 140.

Finally, the processor 134 estimates a lateral acceleration (Ny) for the vehicle 10 (FIG. 1). The processor 134 transmits Ny to the waypoint follower 132 via a lateral acceleration signal 141. In one embodiment, the processor 134 utilizes the following equation to determine Ny:

Ny=(Vx̂2)/r_turn (5)

where Vx is the longitudinal velocity of the vehicle 10 (FIG. 1) and r_turn is the turn radius of CG for the vehicle 10 (as described above with reference to FIG. 1). Methods for calculating r_turn are well known by one who is skilled in the art and will not be discussed in detail herein.

In other embodiments, Ny may be determined using the equation:

Ny=Y*Vx (6)

where Y is the yaw rate of the vehicle 10 determined as described above with reference to FIG. 4.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An apparatus for determining a navigational state of a vehicle, the vehicle having at least one pivotable wheel and a plurality of front wheels, the apparatus comprising:
a steering angle sensor coupled to the at least one pivotable wheel for determining a steering angle;
a plurality of wheel speed sensors each coupled to a different one of the plurality of front wheels for determining the longitudinal angular velocity of each of the plurality of front wheels
a GPS receiver coupled to the vehicle for receiving GPS positioning data; and
a processor, coupled to the steering angle sensor, the plurality of wheel speed sensors, and the GPS receiver, the processor configured to:
determine a yaw rate for the vehicle based on the GPS positioning data, the steering angle, and the longitudinal angular velocity of each of the plurality of front wheels; and
integrate the yaw rate to determine a heading for the vehicle.

2. The apparatus of claim 1, wherein the processor is further configured to determine an x-component of a velocity of the vehicle based on the longitudinal angular velocity of each of the plurality of front wheels.

3. The apparatus of claim 2, wherein the processor is further configured to:
determine a y-component of the velocity of the vehicle based on the x-component of the velocity and the steering angle;
transform the x-component of the velocity into a first directional velocity and the y-component of the velocity into a second directional velocity oriented within an inertial directional coordinate system having a first axis that extends in the North direction and a second axis that extends in the East direction.

4. The apparatus of claim 3, wherein:
the first directional velocity comprises a velocity of the vehicle in the North direction; and
the second directional velocity comprises a velocity of the vehicle in the East direction.

5. The apparatus of claim 4, wherein the processor is further configured to:
determine a North velocity adjustment and an East velocity adjustment;
adjust the first directional velocity by the North velocity adjustment;
adjust the second directional velocity by the East velocity adjustment;
integrate the adjusted first directional velocity to determine a distance in the North direction from a reference position; and
integrate the adjusted second directional velocity to determine a distance in the East direction from a reference position.

6. The apparatus of claim 5, wherein the plurality of front wheels comprises a front left wheel and a front right wheel and the processor is further configured to determine the x-component of the velocity of the vehicle according to:
Vx=r_wheels(ωL+ωR)/2
where:
Vx is the x-component of the velocity of the vehicle;
r_wheels is a average of the radii of the front left wheel and the front right wheel;
ωL is a longitudinal angular velocity of the front left wheel; and
ωR is a longitudinal angular velocity of the front right wheel.

7. The apparatus of claim 6, wherein the at least one pivotable wheel comprises the front left wheel and the front right wheel, the vehicle further comprises at least one rear wheel, and the processor is further configured to determine the y-component of the velocity of the vehicle according to:
Vy=−(Lr/B)Vx tan δ
where:
Vy is the y-component of the velocity of the vehicle;
Lr is the distance between the center of gravity of the vehicle and a nearest point on a line that extends between the position where the at least one rear wheel is coupled to the vehicle;
B is the wheel base of the vehicle;
Vx is the x-component of the velocity of the vehicle; and
δ is the steering angle.

8. The apparatus of claim 6, wherein the at least one pivotable wheel comprises at least one rear wheel and the processor is further configured to determine the y-component of the velocity of the vehicle according to:
Vy=−(Lf/B)Vx tan δ
where:
Vy is the y-component of the velocity of the vehicle;
Lf is the distance between the center of gravity of the vehicle and a nearest point on a line that extends between the positions where the front left wheel and the front right wheel are coupled to the vehicle;
B is the wheel base of the vehicle;
Vx is the x-component of the velocity of the vehicle; and
δ is the steering angle.

9. The apparatus of claim 7, wherein the processor is further configured to determine a first yaw rate of the vehicle according to:
Y1=(1/B)Vx tan δ
where:
Y1 is the first yaw rate;
B is the wheel base of the vehicle;
Vx is the x-component of the velocity of the vehicle; and
δ is the steering angle.

10. The apparatus of claim 9, wherein the processor is further configured to determine a second yaw rate for the vehicle according to:
Y2=(r_wheels/W)(ωL−ωR)
where:
Y2 is the second yaw rate of the vehicle;
r_wheels is the average of the radii of the front left wheel and the front right wheel;
W is the track width of the vehicle;
ωL is a longitudinal angular velocity of the front left wheel; and
ωR is a longitudinal angular velocity of the front right wheel.

11. The apparatus of claim 10, wherein the processor is further configured to:
determine an average yaw rate based on an average of the first yaw rate and the second yaw rate;
generate a yaw rate adjustment; and
determine the yaw rate by adding the yaw rate adjustment to the average yaw rate.

12. The apparatus of claim 2, wherein the processor is further configured to determine a lateral acceleration of the vehicle based on the x-component of the velocity of the vehicle and the yaw rate.

13. A method for determining a navigational state of a vehicle, the vehicle comprising at least one pivotable wheel, a front left wheel, and a front right wheel, the method comprising:
receiving a steering angle from a steering angle sensor coupled to the at least one pivotable wheel;
receiving a longitudinal angular velocity of the front left wheel from a front left wheel speed sensor coupled to the front left wheel;
receiving a longitudinal angular velocity of the front right wheel from a front right wheel speed sensor coupled to the front right wheel;
receiving GPS positioning data from a GPS receiver;
determining a yaw rate for the vehicle based on the longitudinal angular velocity of the front left wheel, the longitudinal angular velocity of the front right wheel, the steering angle, and the GPS positioning data;
integrating the yaw rate to determine a heading of the vehicle; and
setting an appropriate steering angle and velocity for the vehicle based on data including the heading.

14. The method of claim 13, further comprising determining an x-component of the velocity of the vehicle based on the longitudinal angular velocity of the front left wheel and the longitudinal angular velocity of the front right wheel.

15. The method of claim 14, further comprising:
determining a y-component of the velocity of the vehicle based on the x-component of the velocity and the steering angle;
transforming the x-component into a first directional velocity of the vehicle in the North direction and the y-component into a second directional velocity of the vehicle in the East direction;
generating a North velocity adjustment and an East velocity adjustment;
adjusting the first directional velocity by the North velocity adjustment and the second directional velocity by the East velocity adjustment;
integrating the adjusted first directional velocity to obtain a first distance in the North direction away from a reference position; and
integrating the adjusted second directional velocity to obtain a second distance in the East direction away from a reference position; and
wherein the step of setting further comprises setting the appropriate steering angle and velocity for the vehicle based on data including the heading, the first distance, and the second distance.

16. The method of claim 15, wherein the step of determining the yaw rate for the vehicle further comprises:
determining a first yaw rate for the vehicle based on the x-component of the velocity of the vehicle and the steering angle;
determining a second yaw rate for the vehicle based on the longitudinal angular velocity of the front left wheel and the longitudinal angular velocity of the front right wheel;
generating a yaw rate adjustment;
determining an average of the first yaw rate and the second yaw rate; and
adding the yaw rate adjustment to the average of the first yaw rate and the second yaw rate.

17. A vehicle control system for determining an appropriate steering angle and velocity for a vehicle, the vehicle comprising a pivotable front left wheel and a pivotable front right wheel, the vehicle control system comprising:
a steering angle sensor coupled to the pivotable front left wheel and the pivotable front right wheel for detecting a steering angle;
a front left wheel speed sensor coupled to the pivotable front left wheel for determining the longitudinal angular velocity for the pivotable front left wheel;
a front right wheel speed sensor coupled to the pivotable front right wheel for determining the longitudinal angular velocity for the pivotable front right wheel;
a GPS receiver coupled to the vehicle for receiving GPS positioning data;
a navigation unit coupled to the vehicle, the steering angle sensor, the front left wheel speed sensor, the front right wheel speed sensor, and the GPS receiver, the navigation unit configured to:
determine a yaw rate for the vehicle based on the GPS positioning data, the steering angle, and the longitudinal angular velocities of the pivotable front left wheel and front right wheel; and
integrate the yaw rate to determine a heading for the vehicle; and
a waypoint follower coupled to the navigation unit and configured to determine the appropriate steering angle and velocity for the vehicle based on data including the heading.

18. The vehicle control system of claim 17, wherein the navigation unit is further configured to:
determine an x-component of the velocity of the vehicle based on the longitudinal angular velocities of the pivotable from left wheel and the pivotable front right wheel;
determine a y-component of the velocity of the vehicle based on the x-component of the velocity and the steering angle; and
transform the x-component into a first directional velocity of the vehicle in the North direction and the y-component of the velocity of the vehicle into a second directional velocity of the vehicle in an East direction based on the heading.

19. The vehicle control system of claim 18, wherein the navigation unit is further configured to:
determine a North velocity adjustment and an East velocity adjustment;
adjust the first directional velocity by the North velocity adjustment;
adjust the second directional velocity by the East velocity adjustment;
integrate the adjusted first directional velocity to determine a first distance in the North direction away from a reference position; and
integrate the adjusted second directional velocity to determine a second distance in the East direction away from a reference position.

20. The vehicle control system of claim 18, wherein the navigation unit is further configured to:
determine a first yaw rate based on the x-component of the velocity of the vehicle and the steering angle;
determine a second yaw rate for the vehicle based on the longitudinal angular velocities of the pivotable front left wheel and the pivotable front right wheel;
generate a yaw rate adjustment;
determine an average of the first yaw rate and the second yaw rate; and
add the yaw rate adjustment to the average of the first yaw rate and the second yaw rate.
